(19) United States
(12) Patent Application Publication
(10) Pub. No.: US 2024/0091578 A1
(43) Pub. Date: Mar. 21, 2024

(54) FLY ASH-BASED FIRE-PREVENTION AND EXTINGUISHING MATERIAL WITH CARBON DIOXIDE MINERALIZED AND STORED, AND PREPARATION METHOD THEREOF

(71) Applicant: CHINA UNIVERSITY OF MINING AND TECHNOLOGY, Jiangsu (CN)

(72) Inventors: Botao QIN, Jiangsu (CN); Xu SHAO, Jiangsu (CN); Quanlin SHI, Jiangsu (CN); Yixuan YANG, Jiangsu (CN); Zujie MA, Jiangsu (CN); Wenjie JIANG, Jiangsu (CN); Hongqi YANG, Jiangsu (CN); Hongbiao SUN, Jiangsu (CN); Qingni MENG, Jiangsu (CN); Dejun WEI, Jiangsu (CN)

(73) Assignee: CHINA UNIVERSITY OF MINING AND TECHNOLOGY, Jiangsu (CN)

(21) Appl. No.: 18/462,383

(22) Filed: Sep. 6, 2023

(30) Foreign Application Priority Data
Sep. 16, 2022 (CN) 202211127088.4

(51) Int. Cl. A62D 1/06

(52) U.S. Cl. CPC A62D 1/06

(57) ABSTRACT

A fly ash-based fire-prevention and extinguishing material with carbon dioxide mineralized and stored, and a preparation method thereof are provided. The preparation method includes: separately weighing 100 parts to 120 parts of water, 1 part to 3 parts of a solid strong alkali, and 20 parts to 40 parts of a fly ash as raw materials, pouring the raw materials into a reactor successively to obtain a resulting mixture, and stirring the resulting mixture at a high rotational speed; adding 10 parts to 20 parts of a solubilizing agent to the reactor, sealing the reactor, introducing carbon dioxide to the reactor at room temperature to maintain a carbon dioxide pressure to obtain a resulting slurry, and stirring the resulting slurry at a high rotational speed; and further introducing carbon dioxide into the reactor to increase the carbon dioxide pressure, and stirring the resulting slurry at a low rotational speed.

### CROSS-REFERENCE TO RELATED APPLICATION

This application claims the priority benefit of China application serial no. 202211127088.4, filed on Sep. 16, 2022. The entirety of the above-mentioned patent application is hereby incorporated by reference herein and made a part of this specification.

### TECHNICAL FIELD

The present disclosure relates to the technical fields of carbon dioxide storage and prevention and control of spontaneous combustion of coal in goaf, and specifically relates to a fly ash-based fire-prevention and extinguishing material with carbon dioxide mineralized and stored, and a preparation method thereof.

### BACKGROUND

The post-combustion capture (PCC) technology based on a coal-fired power plant is a very important technical route of carbon capture, utilization, and storage (CCUS). The carbon dioxide mineralization and storage technology has advantages such as large storage capacity, safety, and permanence, and a fly ash, as a raw material for carbon dioxide mineralization and storage, has advantages such as high material reactivity, no need for pretreatment, easy acquisition near carbon dioxide emission sources, and low cost.

Coal is a main energy source supporting China's development, but coal mining is facing the serious threat of spontaneous combustion of coal. Among the various fire prevention and extinguishing technologies for controlling the spontaneous combustion of coal in goaf, the fly ash grouting technology is widely used in coal mines for preventing and controlling the spontaneous combustion of coal due to its advantages such as fire extinguishing and cooling, coal covering, excellent filling and blocking effects, and very low cost. In the fly ash grouting technology, a fly ash and water are mixed and stirred, and then the resulting slurry is delivered to an area such as goaf where the spontaneous combustion of coal often occurs. On the one hand, the slurry absorbs heat through water evaporation to play a role of fire extinguishing and cooling, and on the other hand, the slurry can bring the fly ash to a target area for filling and blocking to wrap coal, so that the coal is insulated from oxygen.

CN110683780A discloses a modified fly ash for carbon dioxide solidification and storage, and a preparation method thereof. However, the preparation method involves a cumbersome process flow, demanding reaction conditions, high material costs, and high time and energy consumption, making it difficult for industrial application.

### SUMMARY

A first objective of the present disclosure is to provide a preparation method of a fly ash-based fire-prevention and extinguishing material with carbon dioxide mineralized and stored, and the preparation method involves mild reaction conditions, a short reaction time, and low requirements for equipment, and is suitable for industrial application.

A second objective of the present disclosure is to provide a fly ash-based fire-prevention and extinguishing material with carbon dioxide mineralized and stored prepared by the preparation method.

To achieve the above objectives, the present disclosure adopts the following technical solutions.

In an aspect, the present disclosure provides a preparation method of a fly ash-based fire-prevention and extinguishing material with carbon dioxide mineralized and stored, including the following steps:
step 1: separately weighing 100 parts to 120 parts of water, 1 part to 3 parts of a solid strong alkali, and 20 parts to 40 parts of a fly ash as raw materials, pouring the raw materials into a reactor successively to obtain a resulting mixture, and stirring the resulting mixture at a rotational speed of 600 rpm to 1,200 rpm for 3 min to 5 min;
step 2: adding 10 parts to 20 parts of a solubilizing agent to the reactor, sealing the reactor, introducing carbon dioxide into the reactor at room temperature to maintain a carbon dioxide pressure in the reactor at 1 bar to 3 bar to obtain a first resulting slurry, and stirring the first resulting slurry at a rotational speed of 600 rpm to 1,200 rpm for 3 min to 5 min; and
step 3: further introducing carbon dioxide into the reactor to allow the carbon dioxide pressure in the reactor to reach 10 bar or more to obtain a second resulting slurry, and stirring the second resulting slurry at a rotational speed of 60 rpm to 100 rpm for 10 min to 15 min to obtain the fly ash-based fire-prevention and extinguishing material with the carbon dioxide mineralized and stored.

As a preferred embodiment of the present disclosure, 120 parts of the water, 3 parts of the solid strong alkali, 20 parts of the fly ash, and 20 parts of the solubilizing agent are used.

As a preferred embodiment of the present disclosure, in the step 1, a mass of an ash with a particle size less than or equal to 100 μm in the fly ash accounts for 80% or more of a total mass of the fly ash; and in the fly ash, a silica content is 30% or more and a calcium oxide content is 10% or more.

As a preferred embodiment of the present disclosure, in the step 2, the solubilizing agent is a nonionic surfactant, and a concentration of the solubilizing agent is 1 wt % to 3 wt %.

As a preferred embodiment of the present disclosure, in the step 2, the solubilizing agent is one or more selected from a group consisting of polyoxyethylene sorbitan monolaurate, polyoxyethylene sorbitan monolaurate sorbate, polyoxyethylene laurate, polyglyceryl fatty acid ester, fatty alcohol polyoxyethylene ether, and polyoxyethylene-polyoxypropylene block copolymer.

As a preferred embodiment of the present disclosure, in the step 1, the solid strong alkali is at least one of sodium hydroxide and potassium hydroxide.

In another aspect, the present disclosure further provides a fly ash-based fire-prevention and extinguishing material with carbon dioxide mineralized and stored prepared by the preparation method.

The fly ash-based fire-prevention and extinguishing material with the carbon dioxide mineralized and stored can be used to prevent and control the spontaneous combustion of coal in a coal mine goaf, and the fly ash slurry with carbon dioxide stored can be delivered to the goaf through a grouting pipeline for fire extinguishing and cooling, coal covering, and filling and blocking. In addition, due to the temperature rise caused by the spontaneous combustion of coal, the prepared fly ash slurry can release a large amount of carbon dioxide to reduce an oxygen concentration in the goaf, thereby achieving an effect of preventing and controlling the spontaneous combustion of coal.

Reaction processes for preparing a C—S—H gel with a fly ash in the present disclosure are shown in FIGURE, and are specifically as follows:

2NaOH+SiO₂═Na₂SiO₃+H₂O \textcircled{1}

2KOH+SiO₂═K₂SiO₃+H₂O \textcircled{2}

CaO+H₂O═Ca(OH)₂ \textcircled{3}

CO₂+H₂O═H₂CO₃ \textcircled{4}

Na₂SiO₃+H₂CO₃═H₂SiO₃+Na₂CO₃ \textcircled{5}

K₂SiO₃+H₂CO₃═H₂SiO₃+K₂CO₃ \textcircled{6}

Ca(OH)₂+H₂CO₃═CaCO₃↓+2H₂O \textcircled{7}

H₂SiO₃+Ca(OH)₂+Ca₂SiO₃+2H₂O \textcircled{8}

2(2CaO·SiO₂)+4H₂O═3CaO·2SiO₂·3H₂O+Ca(OH)₂ \textcircled{9}

2(3CaO·SiO₂)+6H₂O═3CaO·2SiO₂·3H₂O+3Ca(OH)₂ \textcircled{10}

Compared with the prior art, the present disclosure has the following advantages.

(1) In the preparation method of the present disclosure, there is no need to add an additional substance with a volcanic ash activity, and free silica contained in the fly ash itself is activated with the strong alkali to enhance the volcanic ash activity of the fly ash. Part of the calcium element in the fly ash exists in a mineral phase and a solid solution, and is hardly leached out in a slurry. In the present disclosure, the fly ash is used to prepare a C—S—H gel based on a volcanic ash reaction, which can increase the solubility of calcium ions in the mineral phase and solid solution, and promote the dissolution of calcium ions in the fly ash, thereby improving the storage capacity of carbon dioxide. In the preparation method of the present disclosure, a silicate needs to be prepared into hydrated silica (metasilicic acid) through a reaction with an inorganic acid, where carbon dioxide to be stored is used as an acid source, such that an additional inorganic acid is not required and the carbon dioxide absorption capacity of the slurry is increased. If an inorganic acid such as hydrochloric acid, sulfuric acid, and nitric acid is used, the cost will be increased, and after being applied to a goaf, the slurry will pollute the mine environment and groundwater source, causing harm to the health of workers. In summary, the preparation method of the present disclosure does not require the addition of an additional substance with a volcanic ash activity and an additional inorganic acid, and involves less consumption of strong alkali, a simple preparation process, normal reaction temperatures, mild reaction conditions, a low comprehensive application cost, and great practical application significance.

(2) The metasilicic acid obtained during the preparation method of the present disclosure is very easily polymerized to form a chain-like substance, and the chain-like substance is an insoluble substance, resulting in low subsequent reaction rates and reduced preparation efficiency. Therefore, in the present disclosure, the nonionic solubilizing agent is added to the slurry, and such a solubilizing agent is chemically non-dissociative, and is not susceptible to pH values of an electrolyte and a solution, and can exist stably in the fly ash slurry with a high metal ion concentration and a high pH value, and can continuously play a role of increasing the solubility of metasilicic acid.

(3) The fly ash slurry with carbon dioxide stored can be used in a coal mine goaf for prevention and control of the spontaneous combustion of coal and for blocking and filling. The fly ash slurry has a temperature-sensitive effect. When remaining coal in the goaf is oxidized to cause the temperature to rise, the slurry can absorb heat released from oxidation of the remaining coal to play a role of fire extinguishing and cooling through water evaporation, and an increase of a temperature of the slurry itself can reduce the solubility of carbon dioxide to release a large amount of carbon dioxide, which can reduce the oxygen concentration in the goaf and inhibit the oxidation of the remaining coal, thereby achieving an effect of prevention and control of the spontaneous combustion of coal. The fly ash slurry contains a large number of micro-scale calcium carbonate and magnesium carbonate particles due to carbon dioxide mineralization, and carbonate ions contained in the slurry can react with calcium and magnesium ions in pores of coal to produce calcium carbonate and magnesium carbonate particles. These particles can seal the pores of coal, reduce a specific surface area (SSA) and a pore volume of coal, and reduce the contact area between coal and oxygen, thereby inhibiting the spontaneous combustion of coal. A fly ash slurry without carbon dioxide stored is strongly alkaline, and will oxidize functional groups such as hydroxyl and carbonyl in coal into carboxyl to reduce the ignition point temperature of coal, which increases a risk of spontaneous combustion of dried remaining coal. The fly ash slurry prepared by the present disclosure is neutral due to absorption of a large amount of carbon dioxide, and will not oxidize oxygen-containing functional groups in coal.

(4) The fly ash is a toxic by-product during coal combustion, and the treatment of fly ashes has become an urgent problem to be solved. The use of a fly ash with carbon dioxide mineralized and stored can reduce the emission of carbon dioxide to protect the environment, and improve the physical and chemical characteristics of the fly ash, such that the fly ash has an industrial application potential and can bring economic benefits. In addition, when the fly ash slurry is used in a coal mine goaf, the mineralized products can be delivered to a deep position underground to achieve the permanent safe storage of carbon dioxide.

### BRIEF DESCRIPTION OF THE DRAWINGS

FIG. 1s a flow chart of preparation of a C—S—H gel with a fly ash.

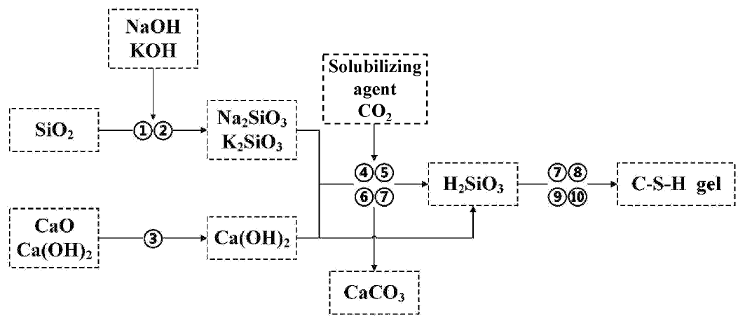

### DETAILED DESCRIPTION OF THE EMBODIMENTS

The present disclosure is further introduced below in conjunction with specific examples, but a claimed protection scope of the present disclosure is not limited thereto.

### Example 1

A fly ash-based fire-prevention and extinguishing material with carbon dioxide mineralized and stored was provided, and the slurry was prepared from the following raw materials in parts by mass: water: 120 parts, fly ash: 40 parts, solubilizing agent: 20 parts, and solid strong alkali: 3 parts.

A mass of an ash with a particle size less than or equal to 100 μm in the fly ash accounted for 80% or more of a total mass of the fly ash; in the fly ash, a silica content was 35.5% and a calcium oxide content was 24.5%; the solubilizing agent was polyoxyethylene sorbitan monolaurate, and a concentration of the solubilizing agent was 3 wt %; and the solid strong alkali was sodium hydroxide.

A preparation method of the fly ash slurry included the following steps.

Step 1: The water, solid strong alkali, and fly ash were separately weighed and poured successively into a reactor, and the resulting mixture was stirred at a rotational speed of 1,000 rpm for 5 min to obtain a carbonated fly ash slurry.

Step 2: The solubilizing agent was added to the reactor, the reactor was sealed, the temperature in the reactor was maintained at room temperature, then carbon dioxide was introduced to maintain a carbon dioxide pressure in the reactor at 3 bar, and the resulting slurry was stirred at a rotational speed of 1,000 rpm for 5 min.

Step 3: Carbon dioxide was further introduced into the reactor to allow the carbon dioxide pressure in the reactor to reach 10 bar, and then the slurry was stirred at a rotational speed of 80 rpm for 15 min to obtain a fly ash slurry with carbon dioxide stored.

### Example 2

A fly ash-based fire-prevention and extinguishing material with carbon dioxide mineralized and stored was provided, which was prepared from the following raw materials in parts by mass: water: 120 parts, fly ash: 40 parts, solubilizing agent: 20 parts, and solid strong alkali: 3 parts.

A mass of an ash with a particle size less than or equal to 100 μm in the fly ash accounted for 80% or more of a total mass of the fly ash; in the fly ash, a silica content was 33.1% and a calcium oxide content was 18.0%; the solubilizing agent was polyoxyethylene sorbitan monolaurate, and a concentration of the solubilizing agent was 3 wt %; and the solid strong alkali was sodium hydroxide.

A preparation method of the fly ash-based fire-prevention and extinguishing material with the carbon dioxide mineralized and stored in this example was the same as that in Example 1.

### Example 3

A fly ash-based fire-prevention and extinguishing material with carbon dioxide mineralized and stored was provided, which was prepared from the following raw materials in parts by mass: water: 120 parts, fly ash: 40 parts, solubilizing agent: 20 parts, and solid strong alkali: 3 parts.

A mass of an ash with a particle size less than or equal to 100 μm in the fly ash accounted for 80% or more of a total mass of the fly ash; in the fly ash, a silica content was 37.5% and a calcium oxide content was 11.6%; the solubilizing agent was polyoxyethylene sorbitan monolaurate, and a concentration of the solubilizing agent was 3 wt %; and the solid strong alkali was sodium hydroxide.

A preparation method of the fly ash-based fire-prevention and extinguishing material with the carbon dioxide mineralized and stored in this example was the same as that in Example 1.

### Example 4

A fly ash-based fire-prevention and extinguishing material with carbon dioxide mineralized and stored was provided, which was prepared from the following raw materials in parts by mass: water: 120 parts, fly ash: 40 parts, solubilizing agent: 20 parts, and solid strong alkali: 2 parts.

A mass of an ash with a particle size less than or equal to 100 μm in the fly ash accounted for 80% or more of a total mass of the fly ash; in the fly ash, a silica content was 35.5% and a calcium oxide content was 24.5%; the solubilizing agent was polyoxyethylene sorbitan monolaurate, and a concentration of the solubilizing agent was 3 wt %; and the solid strong alkali was sodium hydroxide.

A preparation method of the fly ash-based fire-prevention and extinguishing material with the carbon dioxide mineralized and stored in this example was the same as that in Example 1.

### Example 5

A fly ash-based fire-prevention and extinguishing material with carbon dioxide mineralized and stored was provided, which was prepared from the following raw materials in parts by mass: water: 120 parts, fly ash: 40 parts, solubilizing agent: 20 parts, and solid strong alkali: 1 part.

A mass of an ash with a particle size less than or equal to 100 μm in the fly ash accounted for 80% or more of a total mass of the fly ash; in the fly ash, a silica content was 35.5% and a calcium oxide content was 24.5%; the solubilizing agent was polyoxyethylene sorbitan monolaurate, and a concentration of the solubilizing agent was 3 wt %; and the solid strong alkali was sodium hydroxide.

A preparation method of the fly ash-based fire-prevention and extinguishing material with the carbon dioxide mineralized and stored in this example was the same as that in Example 1.

### Example 6

A fly ash-based fire-prevention and extinguishing material with carbon dioxide mineralized and stored was provided, which was prepared from the following raw materials in parts by mass: water: 120 parts, fly ash: 40 parts, solubilizing agent: 10 parts, and solid strong alkali: 3 parts.

A mass of an ash with a particle size less than or equal to 100 μm in the fly ash accounted for 80% or more of a total mass of the fly ash; in the fly ash, a silica content was 35.5% and a calcium oxide content was 24.5%; the solubilizing agent was polyoxyethylene sorbitan monolaurate, and a concentration of the solubilizing agent was 3 wt %; and the solid strong alkali was sodium hydroxide.

A preparation method of the fly ash-based fire-prevention and extinguishing material with the carbon dioxide mineralized and stored in this example was the same as that in Example 1.

### Example 7

A fly ash-based fire-prevention and extinguishing material with carbon dioxide mineralized and stored was provided, which was prepared from the following raw materials in parts by mass: water: 120 parts, fly ash: 30 parts, solubilizing agent: 20 parts, and solid strong alkali: 3 parts.

A mass of an ash with a particle size less than or equal to 100 μm in the fly ash accounted for 80% or more of a total mass of the fly ash; in the fly ash, a silica content was 35.5% and a calcium oxide content was 24.5%; the solubilizing agent was polyoxyethylene sorbitan monolaurate, and a concentration of the solubilizing agent was 3 wt %; and the solid strong alkali was sodium hydroxide.

A preparation method of the fly ash-based fire-prevention and extinguishing material with the carbon dioxide mineralized and stored in this example was the same as that in Example 1.

### Example 8

A fly ash-based fire-prevention and extinguishing material with carbon dioxide mineralized and stored was provided, which was prepared from the following raw materials in parts by mass: water: 120 parts, fly ash: 20 parts, solubilizing agent: 20 parts, and solid strong alkali: 3 parts.

A mass of an ash with a particle size less than or equal to 100 μm in the fly ash accounted for 80% or more of a total mass of the fly ash; in the fly ash, a silica content was 35.5% and a calcium oxide content was 24.5%; the solubilizing agent was polyoxyethylene sorbitan monolaurate, and a concentration of the solubilizing agent was 3 wt %; and the solid strong alkali was sodium hydroxide.

A preparation method of the fly ash-based fire-prevention and extinguishing material with the carbon dioxide mineralized and stored in this example was the same as that in Example 1.

The fly ash slurries prepared in Examples 1 to 8 each were subjected to vacuum suction filtration, vacuum drying, grinding, and the like, and then the storage capacity of carbon dioxide in each of the fly ash slurries was determined by thermogravimetric analysis-mass spectrometry (TGA-MS) to evaluate the ability of each of the fly ash slurries to mineralize and store carbon dioxide.

Specific data is shown in Table 1.

It can be seen from Table 1 and Examples 1 to 3 that the use of a fly ash with a high calcium oxide content can significantly increase a storage capacity of carbon dioxide to 166.78 g/kg, and this is because a fly ash slurry allows storage of carbon dioxide mainly through a reaction of calcium ions with dissolved carbon dioxide to produce a calcium carbonate precipitate.

It can be seen from Examples 1, 4, and 5 that the larger the amount of the strong alkali added during preparation, the larger the storage capacity of carbon dioxide, and this is because the higher the concentration of the strong alkali in the fly ash slurry, the more the activated free silica and the more the generated C—S—H gel, such that increased calcium can be dissolved from a mineral phase and a solid solution to increase the storage capacity of carbon dioxide.

It can be seen from Examples 1 and 6 that, after a content of the solubilizing agent in the fly ash slurry is increased, the storage capacity of carbon dioxide will also be increased significantly, and this is because the solubilizing agent increases the solubility of metasilicic acid, such that increased metasilicic acid participates in the subsequent reaction to produce an increased amount of the C—S—H gel.

It can be seen from Examples 1, 7, and 8 that an increase of a water-solid ratio can also promote the storage of carbon dioxide in the fly ash slurry to some degree.

### Example 9

The fly ash slurry prepared in Example 1 was used for preventing and controlling the spontaneous combustion of coal in a closed coal mine goaf. The fly ash slurry with carbon dioxide stored was delivered to the goaf through a pipeline, and on the day before and after the application of the fly ash slurry, a gas in the goaf was collected and subjected to composition analysis. Composition analysis results are shown in Table 2.

TABLE 1
Storage capacities of carbon dioxide in the fly ash
slurries prepared in Examples 1 to 8

| | Parts | Parts | Parts | | Storage |
|---|---|---|---|---|---|
| | of the | of the | of the | Calcium | capacity |
| | fly | solubilizing | strong | oxide | of carbon |
| Example | ash | agent | alkali | content | dioxide |
| 1 | 40 | 20 | 3 | 24.5% | 166.78 g/Kg |
| 2 | 40 | 20 | 3 | 18.0% | 124.52 g/Kg |
| 3 | 40 | 20 | 3 | 11.6% | 72.26 g/Kg |
| 4 | 40 | 20 | 2 | 24.5% | 152.56 g/Kg |
| 5 | 40 | 20 | 1 | 24.5% | 143.64 g/Kg |
| 6 | 40 | 10 | 3 | 24.5% | 156.25 g/Kg |
| 7 | 30 | 20 | 3 | 24.5% | 169.31 g/Kg |
| 8 | 20 | 20 | 3 | 24.5% | 179.04/Kg |

TABLE 2
Composition analysis results of the gas in the goaf before
and after the application of the fly ash slurry

| | Oxygen | Carbon dioxide |
|---|---|---|
| Gas collection time | concentration | concentration |
| Before the application of the | 6.2454% | 2.7237% |
| fly ash slurry | | |
| After the application of the | 4.7376% | 3.6841% |
| fly ash slurry | | |

It can be seen from Table 2 that, after the application of the fly ash slurry with carbon dioxide stored, the oxygen concentration in the closed goaf is decreased from 6.2454% to 4.7376%, which meets the requirement that an oxygen concentration in a closed area should be no more than 5.0% stipulated in the “Detailed Rules for Fire Prevention and Extinguishing of Coal Mine”. This is because the slurry absorbs heat released by oxidation of remaining coal in goaf when the remaining coal is oxidized and heated, and an increase of a temperature of the slurry itself reduces the solubility of carbon dioxide to release a large amount of carbon dioxide, thereby reducing an oxygen concentration in the goaf. Therefore, it can be known that the fly ash-based fire-prevention and extinguishing material with the carbon dioxide stored can significantly prevent and control the spontaneous combustion of coal in goaf.

### Example 10

A filtrate of the fly ash slurry prepared in Example 1 was mixed with long-flame coal, the resulting mixture was allowed to stand for 5 d and then dried, and then an SSA and pore volume of the coal were measured by SSA and pore size analyzers, respectively. Test data is shown in Table 3.

It can be seen from Table 3 that, after the coal sample is treated with the filtrate, the SSA and pore volume of the coal sample both are reduced. This is because pores of the treated coal sample are filled with the filtrate, a calcium carbonate crystal is precipitated from the filtrate after drying, and dissolved calcium and magnesium in the coal can react with carbonate ions in the filtrate to produce calcium carbonate and magnesium carbonate precipitates. Because the pores are blocked due to adsorption or precipitation, the reduction of the SSA and pore volume can effectively slow down an oxidation reaction of the coal sample.

TABLE 3
Changes of the SSA and pore volume before and after
treatment with the filtrate of the fly ash slurry

| Sample | SSA (m²/g) | Pore volume (cc/g) |
|---|---|---|
| Raw coal sample | 2.28 | 0.00402 |
| Treated coal sample | 1.49 | 0.00268 |

In addition to sodium hydroxide used in the above examples, potassium hydroxide or a mixture of sodium hydroxide and potassium hydroxide may be used as the solid strong alkali.

In addition to polyoxyethylene sorbitan monolaurate used in the above examples, another nonionic surfactant may be used as the solubilizing agent, such as polyoxyethylene sorbitan monolaurate sorbate, polyoxyethylene laurate, polyglyceryl fatty acid ester, fatty alcohol polyoxyethylene ether, and polyoxyethylene-polyoxypropylene block copolymer.

The above examples are merely preferred technical solutions of the present disclosure, and may not be construed as a limitation to the present disclosure. The examples in the present disclosure and features in the examples may be combined with each other in a non-conflicting situation. The protection scope of the present disclosure should be subject to the technical solutions described in the claims, including the equivalent replacements of the technical features in the technical solutions, that is, equivalent replacements or improvements made without departing from the scope should fall within the protection scope of the present disclosure.

What is claimed is:

1. A preparation method of a fly ash-based fire-prevention and extinguishing material with carbon dioxide mineralized and stored, comprising the following steps:
step 1: separately weighing 100 parts to 120 parts of water, 1 part to 3 parts of a solid strong alkali, and 20 parts to 40 parts of a fly ash as raw materials, pouring the raw materials into a reactor successively to obtain a resulting mixture, and stirring the resulting mixture at a rotational speed of 600 rpm to 1,200 rpm for 3 min to 5 min, wherein a mass of an ash with a particle size less than or equal to 100 μm in the fly ash accounts for 80% or more of a total mass of the fly ash; and in the fly ash, a silica content is 30% or more and a calcium oxide content is 10% or more;
step 2: adding 10 parts to 20 parts of a solubilizing agent to the reactor, sealing the reactor, introducing carbon dioxide into the reactor at room temperature to maintain a carbon dioxide pressure in the reactor at 1 bar to 3 bar to obtain a first resulting slurry, and stirring the first resulting slurry at a rotational speed of 600 rpm to 1,200 rpm for 3 min to 5 min, wherein the solubilizing agent is one or more selected from a group consisting of polyoxyethylene sorbitan monolaurate, polyoxyethylene sorbitan monolaurate sorbate, polyoxyethylene laurate, polyglyceryl fatty acid ester, fatty alcohol polyoxyethylene ether, and polyoxyethylene-polyoxypropylene block copolymer, and a concentration of the solubilizing agent is 3 wt %; and
step 3: further introducing the carbon dioxide into the reactor to allow the carbon dioxide pressure in the reactor to reach 10 bar or more to obtain a second resulting slurry, and stirring the second resulting slurry at a rotational speed of 60 rpm to 100 rpm for 10 min to 15 min to obtain the fly ash-based fire-prevention and extinguishing material with the carbon dioxide mineralized and stored.

2. The preparation method of the fly ash-based fire-prevention and extinguishing material with the carbon dioxide mineralized and stored according to claim 1, wherein a ratio of the raw materials is 120 parts of the water, 3 parts of the solid strong alkali, 20 parts of the fly ash, and 20 parts of the solubilizing agent.

3. The preparation method of the fly ash-based fire-prevention and extinguishing material with the carbon dioxide mineralized and stored according to claim 2, wherein in the step 1, the solid strong alkali is at least one of sodium hydroxide and potassium hydroxide.

4. The preparation method of the fly ash-based fire-prevention and extinguishing material with the carbon dioxide mineralized and stored according to claim 1, wherein in the step 1, the solid strong alkali is at least one of sodium hydroxide and potassium hydroxide.

5. A fly ash-based fire-prevention and extinguishing material with carbon dioxide mineralized and stored prepared by the preparation method according to claim 1.

6. A fly ash-based fire-prevention and extinguishing material with carbon dioxide mineralized and stored prepared by the preparation method according to claim 2.

7. A fly ash-based fire-prevention and extinguishing material with carbon dioxide mineralized and stored prepared by the preparation method according to claim 3.

8. A fly ash-based fire-prevention and extinguishing material with carbon dioxide mineralized and stored prepared by the preparation method according to claim 4.
